(19) United States
(12) Patent Application Publication
(10) Pub. No.: US 2011/0016255 A1
(43) Pub. Date: Jan. 20, 2011

(54) COMPUTER STSTEM

(75) Inventors: MAO-SHUN HSI, Tu-Cheng (TW); SAN-YUAN CHUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/631,566

(22) Filed: Dec. 4, 2009

(30) Foreign Application Priority Data
Jul. 16, 2009 (CN) 200910304421.2

(51) Int. Cl. G06F 13/00

(52) U.S. Cl. 710/316

(57) ABSTRACT

A computer system includes a host computer and a monitor connected to the host computer via an integrated digital video interface (DVI-I) connection, and a signal switching circuit. The DVI-I supports both digital/analog signals and generating a hot plug detection signal to identify an/a analog or digital display mode of the monitor. The signal switching circuit is capable of connecting the DVI-I to analog system management bus (SMBUS) if the monitor is in the analog display mode, and connecting the DVI-I to digital SMBUS if the monitor is in the digital display mode.

### BACKGROUND

1. Technical Field

The present disclosure relates to computer systems, and more particularly to a computer system capable of automatically connecting a video interface to an analog/digital system management bus (SMBUS).

2. Description of Related Art

Nowadays, more and more computer devices use digital monitors instead of analog monitors (e.g., VGA monitors). The digital monitors usually use DVI (Display Video Interface) connectors. The DVI connectors can be designed to support only digital signals (e.g., DVI-D connectors) or support both digital signals and analog signals (e.g., DVI-I connectors). The DVI-I connectors combine digital and analog video interfaces and are suitable for both analog monitors and digital monitors.

If a computer system uses the DVI-I connector, a monitor of the computer system can operate in either an analog display mode or a digital display mode. The DVI-I connector includes a display data channel (DDC) interface connected to an analog or digital system management bus (SMBUS). SMBUS is a two-wire bus and consists of a clock line and a data line. The DVI-I should be connected to the analog SMBUS if the monitor is in the analog display mode, and connected to the digital SMBUS if the monitor is in the digital display mode. However, in the typical computer system, the DVI-I connector cannot automatically connect to the correct SMBUS according to the display mode.

Therefore, a computer system overcoming the above shortcomings is desired.

### BRIEF DESCRIPTION OF THE DRAWINGS

FIG. 1 is an embodiment of a computer system.

FIG. 2 illustrates a signal switching circuit of the computer system shown in FIG. 1.

FIG. 3A is a schematic structure of a first integrated circuit in FIG. 2.

FIG. 3B is a schematic structure of a second integrated circuit in FIG. 2.

FIG. 4 illustrates a typical DVI-I connector.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

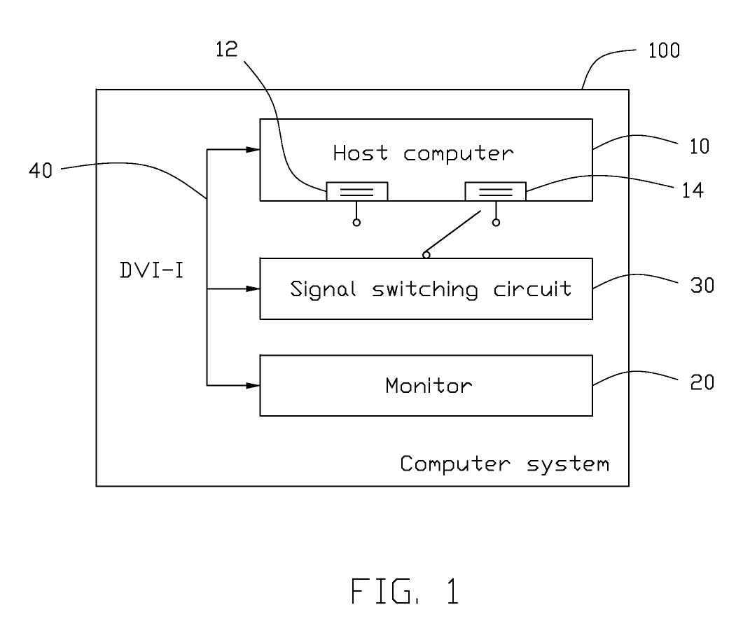

Referring to FIG. 1, an embodiment of a computer system 100 includes a host computer 10, a monitor 20, a signal switching circuit 30 and a DVI-I (integrated digital video interface) cable 40 connecting DVI-I interfaces of the host computer 10 and the monitor 20.

The host computer 10 includes an analog SMBUS 12 and a digital SMBUS 14. The analog SMBUS 12 includes an analog clock line RDDCA_CLK_RC and an analog data line RDDCA_DATA_RC, and the digital SMBUS 14 includes a digital clock line SDDC_CLK and a digital data line SDDC_DATA. The analog SUBUS has different lines with respect to the digital SUBUS. The signal switching circuit 20 is configured to connect the DVI-I interface of the monitor 20 to the analog or digital SMBUS according to a display mode of the monitor 20.

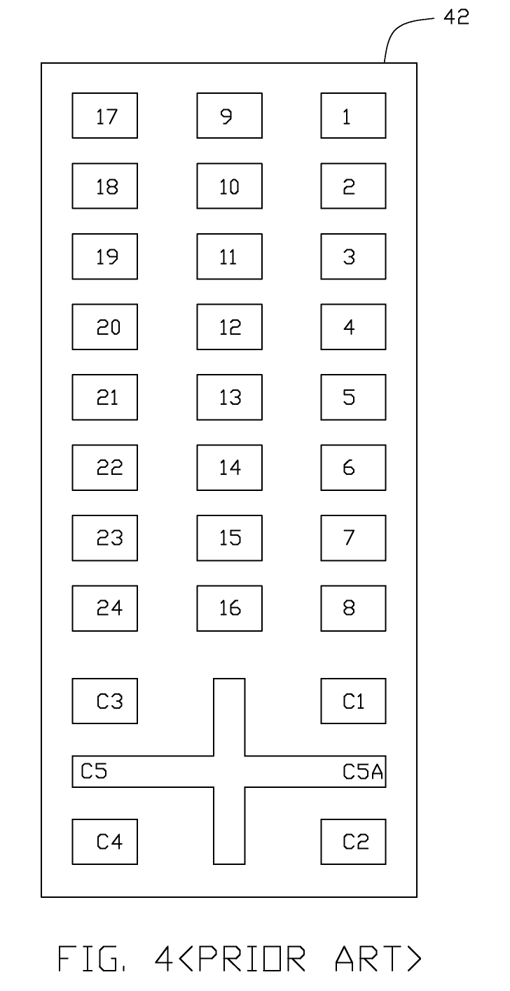

The DVI-I cable 40 has a DVI-I connector 42 (see FIG. 4) at each end thereof. The DVI-I connector 42 supports both analog signals and digital signals, and the monitor 20 can function as an analog monitor to implement the analog signals or a digital monitor to implement the digital signals. The following diagram is a listing of pin assignments of the DVI-I connector 42:

### Pin Signal Assignment Signal Description

1 T.M.D.S Data 2− T.M.D.S (Transition minimized differential signaling)
2 T.M.D.S Data 2+ link #0 channel #2 differential pair
3 T.M.D.S Data 2/4 Shield Shared shield for T.M.D.S link #0 channel #2 and link #1 channel #1
4 T.M.D.S Data 4− T.M.D.S link #1 channel #1 differential pair
5 T.M.D.S Data 4+
6 DDC Clock The clock line for the DDC (display data channel) interface
7 DDC Data The data line for the DDC interface
8 Analog Vertical Sync Vertical synchronization signal for the analog interface
9 T.M.D.S Data 1− T.M.D.S link #0 channel #1 differential pair
10 T.M.D.S Data 1+
11 T.M.D.S Data 1/3 Shield Shared shield for T.M.D.S link #0 channel #1 and link #1 channel #0
12 T.M.D.S Data 3− T.M.D.S link #1 channel #0 differential pair
13 T.M.D.S Data 3+
14 +5V Power +5 volt signal provided by the system to enable the monitor to provide EDID (Extended display identification data) when the monitor is not powered
15 Ground Ground reference for +5 volts power pin
16 Hot Plug Detection Signal is driven by monitor to enable the system to identify the presence of a monitor
17 T.M.D.S Data 0− T.M.D.S link #0 channel #0 differential pair
18 T.M.D.S Data 0+
19 T.M.D.S Data 0/5 Shield Shared shield for T.M.D.S link #0 channel #0 and link #1 channel #2
20 T.M.D.S Data 5− T.M.D.S link #1 channel #2 differential pair
21 T.M.D.S Data 5+
22 T.M.D.S Clock Shield Shield for T.M.D.S clock differential pair
23 T.M.D.S Clock+ T.M.D.S Clock differential pair
24 T.M.D.S Clock−
C1 Analog Red Analog Red signal
C2 Analog Green Analog Green signal
C3 Analog Blue Analog Blue signal
C4 Analog Horizontal Sync Horizontal synchronization signal for the analog interface
C5 Analog Ground Common ground for analog signals.

The DDC Clock (DDC_CLK) pin and the DDC Data (DDC_DAT) pin of the DVI-I connector 42 should be connected to the analog SMBUS 12 when the monitor 20 operates in analog display mode and connected to the digital SMBUS 14 when the monitor 20 is in a digital display mode. A signal on the hot plug detection pin of the DVI-I connector 42 is driven by the monitor 20 to a low level if the monitor 20 is in the analog display mode or to a high level if the monitor is in the digital display mode.

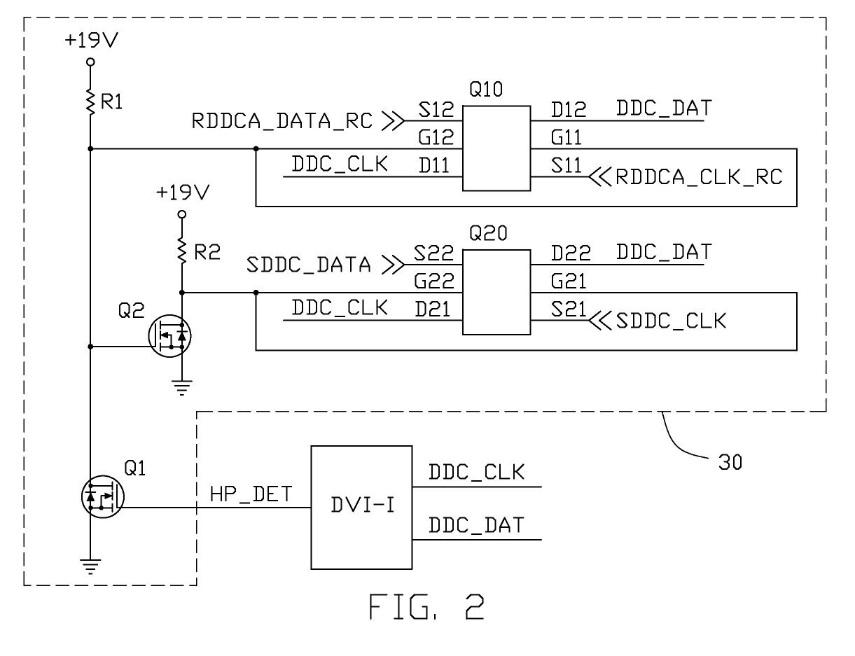

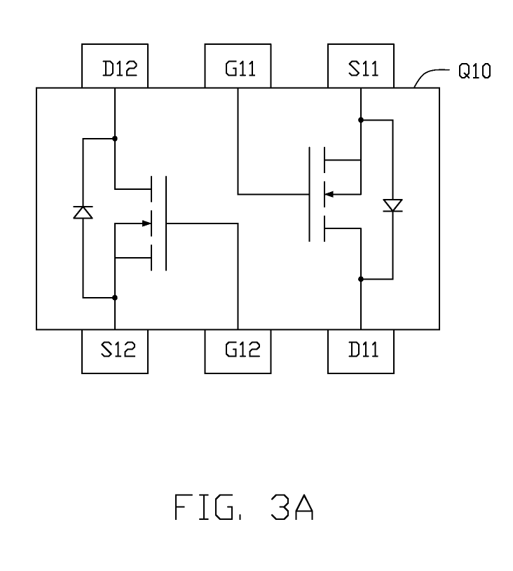

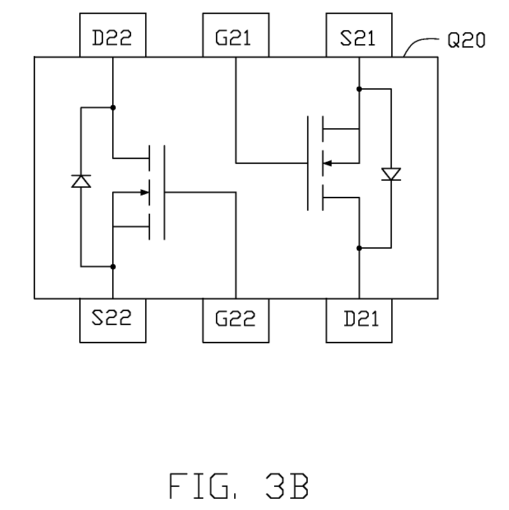

Referring to FIG. 2 and FIGS. 3A-3B, the signal switching circuit 30 includes a first transistor Q1, a second transistor Q2, a first integrated circuit Q10, and a second integrated circuit Q20. In one embodiment, the first transistor Q1 and the second transistor Q2 are both enhancement mode N-channel MOSFETS. Each of the first integrated circuit Q10 and the second integrated circuit Q20 includes a pair of enhancement mode N-channel MOSFETS (see FIGS. 3A-3B). Each of the MOSFETS has gate, drain, and source electrodes and can be used as a switch.

The first transistor gate is connected to the hot plug detection (HP_DET) pin of the DVI-I connector 42 to receive the HP_DET signal from the monitor 20. The first transistor drain is coupled to a +19 volts signal via a resistor R1 and connected with the first integrated circuit pins G11 and G12. The first transistor source is connected to ground. The first integrated circuit pins D11 and D12 are respectively connected to the DDC_CLK pin and the DDC_DAT pin of the DVI-I connector 42. The first transistor pins S11 and S12 are connected to the analog clock line (RDDCA_CLK_RC) and the analog data line (RDDCA_DATA_RC) of the analog SMBUS 12.

The second transistor gate is connected to the first transistor drain. The second transistor drain is coupled to the +19 volts signal via a resistor R2 and connected to the second integrated circuit pins G21 and G22. The second transistor source connected to ground. The second integrated circuit pins D21 and D22 of are respectively connected to the DDC_CLK pin and the DDC_DAT pin of the DVI-I connector 42. The second integrated circuit pins S21 and S22 are connected to the digital clock line (SDDC_CLK) and the digital data line (SDDC_DATA) of the digital SMBUS 14.

When the monitor 20 is in the analog display mode, the HP_DET signal is at low level. The first transistor Q1 is switched off. The first integrated circuit pins G1 and G2 are at high level to switch on the MOSFETS in the first integrated circuit Q10. Thus, pins D11, D12 of Q10 are connected to pins S11, S12 of Q10, and the DDC_CLK, DDC_DAT pins of the DVI-I connector 42 are connected to the analog clock line (RDDCA_CLK_RC) and the analog data line (RDDCA_DATA_RC) of the analog SMBUS 12 for transmitting analog signals. Simultaneously, the second transistor Q2 is switched on to connect pins G21, G22 of Q20 to ground. MOSFETS in the second integrated circuit Q20 are switched off. The DDC_CLK and DDC_DAT pins of the DVI-I connector 42 is disconnected from the digital clock line (SDDC_CLK) and the digital data line (SDDC_DATA) of the digital SMBUS 14. Therefore, the digital signals on the digital SMBUS can not disturb the monitor 20.

When the monitor 20 is in the digital display mode, the HP_DET signal is at high level. The first transistor Q1 is switched on. The second transistor Q2 is switched off. The second integrated circuit pins G1 and G2 are at high level to switch on the MOSFETS in the second integrated circuit Q20. Thus, pins D21, D22 of Q20 are connected to pins S21, S22 of Q20, and the DDC_CLK, DDC_DAT pins of DVI-I connector 42 is connect to the digital clock line (SDDC_CLK) and the digital data line (SDDC_DATA) of the digital SMBUS 14 for transmitting digital signals. Simultaneously, since the first transistor Q1 is switched on, pins G11, G12 of Q10 are connected to ground and at low level. MOSFETS in the first integrated circuit Q10 are switched off, and the DVI-I connector 42 is disconnected from the analog clock line (RDDCA_CLK_RC) and the analog data line (RDDCA_DATA_RC) of the analog SMBUS 12.

In one embodiment, the signal switching circuit 30 is capable of automatically connecting the DDC_CLK, DDC_DAT pins of DVI-I connector 42 to the analog or digital SMBUS according to a display mode of the monitor 20. Thus, the computer system 100 is capable of transmitting correct SMBUS signals, and it operates regardless of whether the monitor 20 is analog or digital.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A computer system comprising:
a host computer comprising an analog bus capable of outputting analog signals and a digital bus capable of outputting digital signals;
a monitor capable of outputting a detection signal that indicates a present display mode of the monitor as either analog or digital;
a signal switching circuit coupled to the host computer and the monitor and capable of receiving the detection signal; the signal switching circuit is capable of alternatively connecting the monitor to the analog bus or the digital bus according to the detection signal.

2. The computer system of claim 1, wherein the signal switching circuit comprises a first integrated circuit capable of connecting a video interface of the monitor to the analog bus when the detection signal indicating the present display mode of the monitor being analog mode, and a second integrated circuit capable of connecting the video interface of the monitor to the digital bus when the detection signal indicating the present display mode of the monitor being digital mode.

3. The computer system of claim 2, wherein the first integrated circuit comprises a third MOSFET and a fourth MOSFET connecting between the video interface of the monitor and the analog bus.

4. The computer system of claim 3, further comprising a first transistor which is a N-channel MOSFET, a first transistor gate is coupled to receive the detection signal, a first transistor drain is coupled to a high level voltage signal and connected to the gates of the third and fourth MOSFETS, a first transistor source is connected to ground.

5. The computer system of claim 4, wherein the second integrated circuit comprises a fifth MOSFET and a sixth MOSFET connecting between the video interface of the monitor and the digital bus.

6. The computer system of claim 5, further comprising a second transistor which is a N-channel MOSFET, a second transistor gate is connected with the drain of the first transistor, a second transistor drain is coupled to the power source and connected to the fifth and sixth MOSFETS' gates, a second transistor source is connected to ground.

7. The computer system of claim 1, wherein the analog bus is an analog system management bus comprising of an analog clock line and an analog data line, and the digital bus is a digital system management bus comprising of a digital clock line and a digital data line.

8. The computer system of claim 7, wherein the monitor is connected to the host computer via an integrated digital video interface (DVI-I) cable, the DVI-I cable has a DVI-I connector, the DVI-I connector has a display data channel (DDC) clock pin and a DDC data pin that is connected to the analog bus or the digital bus according to the present display mode of the monitor.

9. A computer system comprising:
a host computer;
a monitor connected to the host computer via an integrated digital video interface (DVI-I) connection, the DVI-I supporting both digital and analog signals and generating a hot plug detection signal to identify an analog or a digital display mode of the monitor;
a signal switching circuit coupled to receive the hot plug detection signal;
wherein the signal switching circuit is capable of connecting the DVI-I to analog system management bus (SMBUS), if the monitor is in the analog display mode, and connecting the DVI-I to digital SMBUS, if the monitor is in the digital display mode.

10. The computer system of claim 9, wherein the analog SMBUS comprises an analog clock line and an analog data line, the digital analog SMBUS signals comprises a digital clock line and a digital data line, and the DVI-I includes display data channel (DDC) clock line and a DDC data line that are capable of connecting to the analog or digital SMBUS clock line and data line.

11. The computer system of claim 10, wherein the hot plug signal is at low level when the monitor is in the analog display mode and at high level when the monitor is in the digital display mode.

12. The computer system of claim 11, wherein the signal switching circuit includes a first transistor and a first integrated circuit; a first transistor drain is connected with the first integrated circuit and coupled to a power source, when the hot plug detection signal is at low level and the first transistor is switched off, the first integrated circuit is capable of being fed with a high voltage signal connecting the DVI-I connector to the analog SMBUS.

13. The computer system of claim 12, wherein the signal switching circuit further includes a second transistor and a second integrated circuit; a second transistor drain is connected with the second integrated circuit and coupled to the power source; when the hot plug detection signal is at high level, the first transistor is switched on, and the second transistor is switched off, the second integrated circuit is capable of connecting the DVI-I connector to the digital SMBUS.

14. The computer system of claim 13, wherein the first transistor and the second transistor are both enhancement mode N-channel MOSFETS; a first transistor gate is coupled to receive the hot plug detection signal, and a first transistor source is connected to ground; a second transistor gate is connected with the first transistor drain, a second transistor source is connected to ground.

15. The computer system of claim 14, wherein the first integrated circuit comprises a pair of transistors capable of connecting the DDC clock line and the DDC data line to the analog clock signal and the analog data signal of the SMBUS.

16. The computer system of claim 14, wherein the second integrated circuit comprises a pair of transistors capable of connecting the DDC clock line and the DDC data line to the digital clock signal and the digital data signal of the SMBUS.
